(19) United States
(12) Patent Application Publication
(10) Pub. No.: US 2021/0142503 A1
(43) Pub. Date: May 13, 2021

(54) Portable Imaging Device

(71) Applicant: King Tester Corporation, Phoenixville, PA (US)

(72) Inventors: James A. Knight, Wayne, PA (US); William O. Knight, Wayne, PA (US)

(21) Appl. No.: 17/090,959

(22) Filed: Nov. 6, 2020

Related U.S. Application Data
(60) Provisional application No. 62/932,804, filed on Nov. 8, 2019.

(51) Int. Cl. G06T 7/64; G01N 21/17; G06T 7/00

(52) U.S. Cl. CPC G06T 7/64; G01N 2021/177; G06T 7/0004; G01N 21/17

(57) ABSTRACT

A portable imaging device including a housing comprising a containment portion connected to a gripping portion, a display screen arranged on a proximal end of the containment portion and an image collection port arranged on a distal end of the gripping portion, an input device arranged on or adjacent to the gripping portion, a digital camera arranged in the housing and configured to capture an image of a surface through the image collection port in response to actuation of the input device, and a computing device arranged in the housing and in communication with the digital camera. The computing device is programmed or configured to determine a diameter of an indentation in a surface based on analyzing the image and determine a hardness value based on the diameter. Also, a method of using the portable image device to determine the hardness of a material.

### CROSS REFERENCE TO RELATED APPLICATIONS

The present application claims the benefit of the filing date and priority to U.S. Provisional Patent Application No. 62/932,804, filed on Nov. 8, 2019, the entire disclosure of which is incorporated by reference herein.

### BACKGROUND OF THE INVENTION

### Field of the Invention

The present application relates to a portable imaging device having a containment portion and a gripping portion and including a self-contained digital camera including magnification, a display screen, a user input interface, and a computing device, and more specifically, to a portable imaging device including a digital camera including magnification, a display screen, a user input interface, and a computing device that is capable of measuring at least one dimension of a feature in the field of vision of the digital camera.

### Description of Related Art

Portable testers for measuring the hardness of materials, and specifically, metal materials include an indenter having a spherical tip that is used to make an indentation in the material being tested. Typically, the spherical tip is a ball having a diameter of 10 mm. The indentation made in the material by the ball using a specified load, typically 60-300 kgf, is measured and converted into a Brinell hardness number (HB), which is

$$\frac{2 F}{π D ( D - \sqrt{D - d} )}$$

where F is the load applied to the ball, D is the ball diameter, and d is the indentation diameter.

Because the indentation made in the material is so small, a microscope is used to measure its diameter (d). Therefore, there is a need for a portable, ergonomic, self-contained imaging system that can automatically measure the diameter of the indentation, calculate the hardness, and store and transfer the data all in a single compact unit.

### SUMMARY OF THE INVENTION

The present invention is direct to a portable imaging device that includes a digital camera including magnification, a visual representation of the image collected by the digital camera, analytics to analyze the image collected by the digital camera, data capture, and file sharing in a self-contained hand held unit with a pleasing ergonomic feel.

The present invention is directed to a portable imaging device, comprising a housing comprising a containment portion having a proximal end and a distal end and a gripping portion having a proximal end and a distal end, the distal end of the containment portion connected to the proximal end of the gripping portion such that the gripping portion extends from the distal end of the containment portion; a display screen arranged on the proximal end of the containment portion and an image collection port arranged on the distal end of the gripping portion; an input device arranged on or adjacent to the gripping portion; a digital camera arranged in the housing and configured to capture an image of a surface through the image collection port in response to actuation of the input device; and at least one computing device arranged in the housing and in communication with the digital camera, the at least one computing device programmed or configured to: determine a diameter of an indentation in a surface based on analyzing the image and determine a hardness value based on the diameter.

The gripping portion may be substantially cylindrical, the containment portion is substantially box-shaped, and/or the containment portion may further comprise a tapered portion to which the gripping portion is connected. At least one of a raised area or a recessed area may be provided on an outer surface of the gripping portion. For example, a first recessed area may be provided on an outer surface of a first side of the gripping portion and at least one second recessed area may be provided on the outer surface of a second side of the gripping portion, where the second side is substantially opposite the first side and the at least one second recessed area is distal to the first recessed portion. The first recessed area and/or the at least one second recessed area may have a concave curvature.

Lighting may be provided around the image collection port, and/or a plane of the image collection port may be parallel to a plane of the display screen.

The present invention is also directed to a method of determining a hardness of a material using the portable imaging device discussed above. A small indentation is placed in the material using an indenter having a diameter using a testing force. The distal end of the gripping portion is placed on the material such that the image collecting port covers a portion of the material containing the indentation, and the input device is activated to capture an image of the indentation. The image is analyzed using the at least one computing device to determine a diameter of the indentation in the surface of the material. A hardness value is determined based on the diameter of the indentation, the object diameter, and the testing force.

The diameter of the indentation may be determined by at least one of the methods of the group consisting of a cube fit method, an orthogonal line method, and a combination thereof. The image may be displayed on the display screen and/or a cursor may be provided on the display screen to assist a user with placement of the indentation within a field of vision of the digital camera. Lighting is provided around the image collection port and the lighting is adjusted to produce contrast between the indentation and a surrounding surface.

The method may further comprise inputting information selected from the group consisting of the object diameter, the testing force, minimum and/or maximum length of a scan of the image, a tolerance adjustment for the minimum and/or maximum length of the scan of the image, a minimum percentage limit for a number of calculated points used to analyze the image, a minimum acceptable measure of a roundness of the indentation determined by comparing how closely horizontal, vertical, and diagonal diameters match one another, and a type of cursor that is provided on the screen. A magnification of the digital camera may be automatically adjusted based on an inputted indenter diameter.

### BRIEF DESCRIPTION OF THE DRAWINGS

FIG. 1 is a front side perspective view of a portable imaging device according to the invention;

FIG. 2 is a rear side perspective view of the portable imaging device of FIG. 1 in use;

FIG. 3 is a front view of the portable imaging device of FIG. 1;

FIG. 4 is a rear view of the portable imaging device of FIG. 1;

FIG. 5 is a first side view of the portable imaging device of FIG. 1;

FIG. 6 is a second side view of the portable imaging device of FIG. 1;

FIG. 7 is a bottom view of the portable imaging device of FIG. 1;

FIG. 8 is a top view of the portable imaging device of FIG. 1;

FIG. 9 is a perspective view of the housing of the portable imaging device of FIG. 1; and

FIG. 10 is a top view the portable imaging of FIG. 1 in use showing a close-up of the display screen.

FIG. 11 is a front side perspective view including contour lines of the surfaces of a portable imaging device according to the invention;

FIG. 12 is a rear side perspective view including contour lines of the surfaces of the portable imaging device of FIG. 11 in use;

FIG. 13 is a front view including contour lines of the surfaces of the portable imaging device of FIG. 11;

FIG. 14 is a rear view including contour lines of the surfaces of the portable imaging device of FIG. 11;

FIG. 15 is a first side view including contour lines of the surfaces of the portable imaging device of FIG. 11;

FIG. 16 is a second side view including contour lines of the surfaces of the portable imaging device of FIG. 11;

FIG. 17 is a bottom view including contour lines of the surfaces of the portable imaging device of FIG. 11; and

FIG. 18 is a top view including contour lines of the surfaces of the portable imaging device of FIG. 11.

### DESCRIPTION OF THE INVENTION

The present invention is directed to a portable imaging device, shown in FIGS. 1-18 comprising a digital camera including magnification, a display screen, a user input interface, and a computing device, (e.g., a microcomputer). Preferably, the portable imaging device is self-contained in a single unit in which the computing device is in communication with the digital camera, display screen, and user input interface.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. In some examples a computing device may be a processor, such as a CPU, microcontroller, microprocessor, and/or the like. A computing device may be a mobile device, such as a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

In non-limiting embodiments, a computing device may execute program instructions to carry out one or more steps. The program instructions may be embedded in the computing device and/or be stored on memory in communication with the computing device.

The components of the portable imaging device 10 are provided in a housing 12 (FIG. 9) as a self-contained unit. The housing 12 may comprise one or more pieces. If the housing 12 comprises more than one piece, the pieces may be joined by any suitable method, for example, screws, rivets, a snap fit connection, and/or adhesive.

The housing 12 comprises two portions. A proximal containment portion 18 houses the display screen 16, the user input interface, the computing device, and, optionally, at least a portion of the digital camera. A distal gripping portion 20 houses at least a portion of the digital camera and includes an image collection port 14. The proximal containment portion 18 of the housing 12 has a proximal end 22 and a distal end 24. The proximal containment portion 18 of the housing 12 may be substantially box-shaped and may include a tapered portion 26 that connects to the distal gripping portion 20.

The distal gripping portion 20 of the housing 12 has a proximal end 28 and a distal end 30. The distal gripping portion 20 of the housing 12 may be elongated and may be substantially cylindrical. The proximal end 28 of the distal gripping portion 20 of the housing 12 is connected to the distal end 24 of the proximal containment portion 18 of the housing 12.

The distal gripping portion 20 of the housing 12 may comprise a portion 32 that includes raised and/or recessed areas on the outer surface that may act as hand or finger grips for the user to grip the portable imaging device 10. The portion 32 may include a first recessed area 34 for accommodating the user's thumb and one or more second recessed area 36 for accommodating the user's fingers. The first recessed area 34 may by proximal to the second recessed area 36 and may be positioned opposite the second recessed area 36 on the outer surface of the distal gripping portion 20. The first recessed area 34 and/or the second recessed area 36 may have a concave curvature.

The image collection port 14 is located on the distal end 30 of the distal gripping portion 20. The plane of the image collection port 14 is parallel to the plane of the display screen 16.

The display screen 16, which may also be the user input interface, may be provided in the proximal end 22 of the proximal containment portion 18 of the housing 12, i.e., the surface of the proximal containment portion 18 of the housing 12 that will be parallel to the surface of the material or part when the image collection port 14 is placed on the material or part during use of the portable imaging device 10. The display screen 16 may be provided in a recess 38 in this surface in order to protect the display screen 16 from damage. A sleeve 40 containing a stylus for use with the user input interface may also be provided on this surface. As explained herein, in non-limiting embodiments, a display screen of a separate device (e.g., such as a mobile computing device) may be used in addition to or alternatively to the display screen 16.

An opening 42 for an input device 44, such as a capture button, used to capture an image and/or an opening 46 for the on/off button 48 may be included in the housing 12 and openings 50 may be provided in the housing 12 for a USB port(s), micro-USB port(s), or other connections. The opening 42 for the input device 44 is arranged in the portion 32 of the distal gripping portion 20 that includes the raised and/or recessed areas that act as hand or finger grips for the user so that the user may easily activate the input device 44 while gripping the portable imaging device 10. For example, the input device 44 may be a button located proximal to and on the same side of the outer surface of the housing 12 as the second recessed area 36.

The portable imaging device 10 includes a digital camera capable of collecting a magnified image of a surface on or above which the image collection port 14 of the portable imaging device 10 is placed. The image collection port 14 may include an aperture in the housing through which a lens of the digital camera views the surface. The lens may be arranged within or recessed back from the image collection port 14. The surface may be magnified 20-100 times, and typically, 20-40 times. The digital camera has an adjustable zoom lens that allows the magnification of the surface to be varied. The digital camera may be provided with a 10× to 20× zoom and the zoom may be digital, optical, or a combination of both digital and optical. The digital camera may be capable of collecting a minimum of an 8 megapixel (MP) image.

The calibration of the digital camera may also be adjusted.

The portable imaging device 10 may include light emitting diodes (LEDs) that provide light to illuminate the surface of the object from which the image is being collected. The intensity of the light provided by the LEDs is variable. The LEDs may be provided in a circular configuration around the image collection port 14 of the portable imaging device 10. Any suitable number of LEDs may be provided, for example, a minimum of 4 LEDs may be provided.

The image that is collected by the digital camera is displayed on the display screen 16. The display screen 16 may show the image in grayscale or in color. The display screen may be a liquid crystal display (LCD) screen and may be a touchscreen. Alternatively or in addition, the image may be displayed on a computer monitor, tablet, phone, television, or another suitable device via a cable or wireless connection to the portable imaging device 10, for example, an HDMI cable, a USB cable, a micro-USB cable, a coaxial cable, another cable capable of electronically communicating data, a radio frequency communication, an optical communication, and/or the like.

An input device 44, such as a capture button, may be provided on the portable imaging device 10. When a user has adjusted the placement of the portable imaging device 10 to obtain the desired field of view, the input device 44 is actuated (e.g., a button pressed) and, in response to such actuation, an image is captured. In non-limiting embodiments, the input device 44 may additionally or alternatively include an inertial sensor, a capacitance sensor, a microphone, a touchscreen, and/or any other like mechanism for a user to provide an input to cause the capture of an image.

The portable imaging device 10 includes an operating system and a functional system residing on the computing device that is completely self-contained within the housing 12 of the portable imaging device 10. The computing device may be a Raspberry Pi or other single-board computing device, as an example, or may be a multi-component computing device. In some non-limiting embodiments, the computing device may include a custom designed circuit board for added functionality.

The computing device includes or is in communication with a data storage device for storing the collected images, data obtained from the collected images, setup data, identifying data, etc. The data storage device may have both read and write access. The data storage device may be a solid state drive, a hard drive, and/or may be a removable storage device, for example, a memory card or USB “thumb” drive.

The digital camera communicates with an image analysis module stored on the computing device which analyzes the magnified image collected by the digital camera. The image analysis module identifies an object present in the image and measures a dimension of at least one feature of the object to within 0.01 mm and, preferably, 0.001 mm. As used herein, the term “module” refers to one or more software functions capable of being executed by a computing device, such as a microcomputer, and/or one or more configured hardware devices or portions thereof. For example, the image analysis module may include a software application outputs data representing the dimension of at least one feature of the object. In some non-limiting examples, the image analysis module may be remote from the digital camera and computing device, such as a software application executed by a remote server computer that is communicated with to perform remote processing tasks.

The image analysis module processes the image collected by the digital camera pixel by pixel to determine changes in color over the entire image and uses the changes in color to identify features in the image and measure at least one dimension of at least one feature in the image.

The image analysis module may include functionality to setup custom settings that can be saved on the data storage device for future use. The image analysis module may also include functionality for date and/or time stamping an image and/or providing the GPS coordinates of the location in which the image was captured.

A user input interface may be used to input data to the portable imaging device 10. The user input interface may be a touchscreen used for the display screen 16 or another suitable device, for example, a small keyboard. The portable imaging device 10 may include a USB port, a micro-USB port, and/or the like to allow communication of the collected images and/or data to a computer or a tablet and/or may have a wireless communication adapter, such as a Bluetooth transmitter, to communicate data via a wireless (e.g., Bluetooth) connection. This connection may also be used to input data to the portable imaging device 10. The portable imaging device 10 may also include a WiFi, Near-Field Communication (NFC), and/or other like transmitter/receiver devices for communication with other devices.

The portable imaging device 10 may include an integral battery or may be powered via an adaptor for connection to a power outlet. The battery may be rechargeable via an adaptor for connection to a power outlet.

When using the portable imaging device 10 to measure the hardness of a material, a small indentation is placed in the material using an indenter having a diameter, for example, a spherical ball or other suitable object. The ball may have a diameter of 2.5-10 mm. The indentation is made in the material by the ball using a specified testing force (load), typically 60-3000 kgf.

The image collection port 14 of the portable imaging device 10 is placed on the surface of the material in the area in which the indentation was made. The image analysis module may default to the last custom settings that were used. Custom settings may include ball diameter, testing force, minimum and/or maximum length of the scan of the image used by the image analysis module, tolerance adjustment for the minimum and/or maximum length of the scan of the image used by the image analysis module, minimum percentage limit for calculated points found on the edge of the impression for a valid test, minimum acceptable measure of the roundness of the impression by comparing how closely the horizontal, vertical, and diagonal diameters match each other, and/or type of cursor (dot, circle, crosshair). The user may input custom settings for the particular material or part that is being measured or may select custom settings for the material or part that have been stored on the data storage device of the computing device using unique material or part identifiers. If stored custom settings are selected, each setting may be modified by the user.

The acceptable values and/or ranges for the testing force and the minimum and/or maximum length of the scan of the image used by the image analysis module may be limited or automatically set by the image analysis module based on the ball diameter. For example:

| Ball | | Min. Scan | Max. Scan |
|---|---|---|---|
| Size (mm) | Load (kgf) | Length (mm) | Length (mm) |
| 2.5 | 62.5, 187.5 | 0.50 | 1.75 |
| 5 | 125, 250, 750 | 1.00 | 3.50 |
| 10 | 500, 1000, 1500, 3000 | 3.00 | 6.56 |

The tolerance adjustment for the minimum and/or maximum length of the scan of the image used by the image analysis module may be limited to the range defined by the minimum scan length and the maximum scan length.

The digital camera zoom may be automatically adjusted by the image analysis module based on the ball diameter. For example, 0× for a 10 mm ball, 2× for a 5 mm ball, and 4× for a 2.5 mm ball may be used. In this manner, the displayed image has approximately the same size regardless of the diameter of the ball that was used to make the indentation.

An image of the surface of the material is shown on the display screen and/or the attached monitor and a cursor is provided to assist the user in the correct placement of the indentation within the field of vision of the digital camera. The user may then capture the image by activating the provided input device 44 or by touching the touchscreen display.

The image analysis module may automatically adjust the digital camera zoom and intensity of the LED lighting to produce the highest contrast between the indentation and the surrounding surface.

After the image is captured, the image analysis module determines the circumference of the indentation in the material that is shown in the collected image and calculates the diameter of the indentation. The diameter may be determined in any suitable manner including: (1) a cube fit method in which the circumference of the indentation is measured and divided by pi; (2) an orthogonal line method where two sets of orthogonal lines at 90 degree angles are used and the points at which those lines intersect the circumference of the circle are used to derive the circumference which is divided by pi; and (3) a hybrid method in which both the cube fit method and the orthogonal line method are used, the average circumference is determined and divided by pi. The user may have pre-selected the method that the image analysis module uses for a particular scan or may change the method at a later time. The image analysis module then uses the diameter of the indentation (d), the diameter of the indenter (D), and the testing force (F) used to make the indentation to determine a Brinell hardness number (HB), which is

$$\frac{2 F}{π D ( D - \sqrt{D - d} )}$$

where F is the testing load applied to the indenter, D is the indenter diameter, and d is the indentation diameter.

The process of capturing the image and calculating the Brinell hardness may take less than 5 seconds, for example, less than 3 seconds, or less than 1 second.

As shown in FIG. 10, the captured image along with any identifiers (REF #), the settings used (BALL, LOAD, FOM, RND), the calculated diameter of the indentation (DIAM), and the calculated Brinell hardness number (BNW) may be displayed on the display screen.

The user may then choose to save this data or the data may be automatically saved. The data may be saved to the integrated data storage device, a removable storage device, and/or an attached computing device. The saved data may be automatically provided with a time stamp, date stamp, and/or GPS latitude/longitude identifier.

The image analysis module may also be configured to provide test block settings in which the settings for the image analysis module are automatically set for a test block that is used to calibrate the indenter (e.g., ball) used for the hardness testing and/or the portable imaging device 10.

The digital camera may also be calibrated using a special calibration mode that may only be available to specific users via a password. The image collection port is placed over a certified stage micrometer and the distance between lines shown on the display screen is adjusted by the user via the user input interface.

As used herein, unless otherwise expressly specified, plural encompasses singular and vice versa. When ranges are given, any endpoints of those ranges and/or numbers within those ranges can be combined with the scope of the present invention. “Including”, “such as”, “for example” and like terms means “including/such as/for example but not limited to”.

Although the invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the spirit and scope of the invention. For example, it is to be understood that the present invention contemplates that, to the extent possible, one or more features of any embodiment can be combined with one or more features of any other embodiment.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

The invention claimed is:

1. A portable imaging device, comprising:
a housing comprising a containment portion having a proximal end and a distal end and a gripping portion having a proximal end and a distal end, the distal end of the containment portion connected to the proximal end of the gripping portion such that the gripping portion extends from the distal end of the containment portion;
a display screen arranged on the proximal end of the containment portion and an image collection port arranged on the distal end of the gripping portion;
an input device arranged on or adjacent to the gripping portion;
a digital camera arranged in the housing and configured to capture an image of a surface through the image collection port in response to actuation of the input device; and
at least one computing device arranged in the housing and in communication with the digital camera, the at least one computing device programmed or configured to: determine a diameter of an indentation in a surface based on analyzing the image and determine a hardness value based on the diameter.

2. The portable imaging device of claim 1, wherein the gripping portion is substantially cylindrical.

3. The portable imaging device of claim 1, wherein the containment portion is substantially box-shaped.

4. The portable imaging device of claim 1, wherein the containment portion is substantially box-shaped, the gripping portion is substantially cylindrical, and the containment portion further comprises a tapered portion to which the gripping portion is connected.

5. The portable imaging device of claim 1, wherein at least one of a raised area or a recessed area is provided on an outer surface of the gripping portion.

6. The portable imaging device of claim 1, wherein a first recessed area is provided on an outer surface of a first side of the gripping portion and at least one second recessed area is provided on the outer surface of a second side of the gripping portion, the second side being substantially opposite the first side and the at least one second recessed area being distal to the first recessed portion.

7. The portable imaging device of claim 6, wherein the first recessed area and/or the at least one second recessed area has a concave curvature.

8. The portable imaging device of claim 1, wherein a plane of the screen is parallel to a plane of the image collection port.

9. The portable imaging device of claim 1, further comprising lighting provided around the image collection port.

10. The portable imaging device of claim 1, further comprising a user input interface.

11. The portable imaging device of claim 10, wherein the user input interface and the display screen are combined as a touch screen.

12. A method of determining a hardness of a material using the portable imaging device of claim 1 comprising:
placing a small indentation in a surface of the material using an indenter having a diameter using a testing force;
placing the distal end of the gripping portion on the material such that the image collection port covers a portion of the material containing the indentation;
activating the input device to capture an image of the indentation;
analyzing the image using the at least one computing device to determine a diameter of the indentation in the surface of the material; and
determining a hardness value based on the diameter of the indentation, the diameter of the indenter, and the testing force.

13. The method of claim 12, wherein the diameter of the indentation is determined by at least one method selected from the group consisting of: a cube fit method, an orthogonal line method, and a combination thereof.

14. The method of claim 12, wherein the image is displayed on the display screen.

15. The method of claim 12, further comprising inputting using a user input interface provided on the portable imaging device information selected from the group consisting of the indenter diameter, the testing force, minimum and/or maximum length of a scan of the image, a tolerance adjustment for the minimum and/or maximum length of the scan of the image, a minimum percentage limit for a number of calculated points used to analyze the image, a minimum acceptable measure of a roundness of the indentation determined by comparing how closely horizontal, vertical, and diagonal diameters match one another, and a type of cursor that is provided on the screen.

16. The method of claim 13, wherein a magnification of the digital camera is automatically adjusted based on an inputted indenter diameter.

17. The method of claim 12, wherein a cursor is provided on the display screen to assist a user with placement of the indentation within a field of vision of the digital camera.

18. The method of claim 12, wherein lighting is provided around the image collection port and the lighting is adjusted to produce contrast between the indentation and a surrounding surface.
